(19) United States
(12) Patent Application Publication
(10) Pub. No.: US 2015/0143210 A1
(43) Pub. Date: May 21, 2015

(54) Content Stitching Templates

(71) Applicant: Microsoft Corporation, Redmond, WA (US)

(72) Inventor: Wing Hong Michael Lam, Bellevue, WA (US)

(73) Assignee: Microsoft Corporation, Redmond, WA (US)

(21) Appl. No.: 14/082,836

(22) Filed: Nov. 18, 2013

(51) Int. Cl. G06F 17/24

(52) U.S. Cl. CPC G06F 17/248
USPC 715/202

(57) ABSTRACT

Content stitching techniques are described in which templates may be created to define a structure for a presentation. Each template may stitch together building blocks associated with different types of content to specify a pre-arranged sequence for content items. Additionally, the templates may include timing data, transitions, and control data to facilitate managed switching back and forth between different types of content in an automatic, seamless manner. The templates are configured to separate the presentation structure from actual content items selected for a particular presentation and may be reusable to produce different presentations based on the same template that are associated with different content. In one approach, content descriptors included in a template may be set differently for individual presentations to designate and arrange content items to create each individual presentation based on the template.

### BACKGROUND

User are increasingly relying upon cloud-based resources for conducting business and personal communications including online meetings, screen-sharing, video chats, messaging, and otherwise using various resources available from service providers. For example, a salesperson may create a sales pitch presentation to present to potential customers in an online setting, such as via an online meeting session. Using traditional techniques, switching between different types of content (e.g., screen sharing, video, slides, a demo, etc.) during the sales pitch presentation may involve manually navigating between and launching various applications and user interfaces to access and present the different types of content. Such manual navigation may be cumbersome and disrupt the timing and flow of the presentation. As a result, the presentation product that is output may appear somewhat awkward and unpolished.

### SUMMARY

Content stitching techniques are described in which templates may be created to define a structure for a presentation. Each template may stitch together building blocks associated with different types of content to specify a pre-arranged sequence for content items. Additionally, the templates may include timing data, transitions, and control data to facilitate managed switching back and forth between different types of content in an automatic, seamless manner. The templates are configured to separate the presentation structure from actual content items selected for a particular presentation and may be reusable to produce different presentations based on the same template that are associated with different content. In one approach, content descriptors included in a template may be set differently for individual presentations to designate and arrange content items to create each individual presentation based on the template.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the following discussion.

FIG. 1 is an illustration of an example operating environment that is operable to employ techniques for content stitching templates.

FIG. 2 is a diagram depicting some details of an example content stitching template in accordance with one or more implementations.

FIG. 3 is a flow diagram depicting an example procedure to form a template in accordance with one or more implementations.

FIG. 4 is a flow diagram depicting an example procedure to generate a presentation based on a template in accordance with one or more implementations.

FIG. 5 is a flow diagram depicting an example procedure to use a saved template to create a particular presentation in accordance with one or more implementations.

FIG. 6 illustrates an example system having devices and component that may be employed to implement aspects of the techniques described herein.

### DETAILED DESCRIPTION

Overview

Manually navigating to switch between different types of content (e.g., screen sharing, video, slides, a demo, etc.) during an online presentation may be cumbersome and disrupt the timing and flow of the presentation. Unfortunately, traditional presentation platforms lack tools to facilitate seamless switching. As a result, users are left to rely upon manual switching, which may appear unpolished.

Content stitching techniques are described herein in which content stitching templates may be created to define a structure for a presentation. Each template may “stitch” together building blocks associated with different types of content to specify a pre-arranged sequence for content items. Additionally, the templates may include timing data, control data, and transitions to facilitate managed switching back and forth between different types of content in an automatic, seamless manner. For instance, a user interface may expose various building blocks that may be selected via the user interface and placed in a specified order to define a presentation structure. The building blocks may include timing data and control data used to manage the way in which switching back and forth between different types of content items occurs. Additionally, the user interface may be operable to select various transitions and effects that occur for the switching that are also reflected by the templates.

The content stitching templates are configured to separate the presentation structure from actual content items selected for a particular presentation and may be reusable to produce different presentations based on the same template that are associated with different content. In one approach, content descriptors included in a template may be set differently for individual presentations to designate and arrange content items to create each individual presentation based on the template. At runtime, content items associated with a presentation may be output sequentially according to the defined structure, timing data, and control data. Content templates may be created using various types of client devices, and presentations produced using the templates may be accessed and controlled using the various devices in traditional computing networks, mobile device platforms, gaming/television environments, and/or cross-platform scenarios. At least some content items may be pre-loaded at appropriate times in the background while other content is actively being presented. The pre-loaded content may then be revealed using designated transitions to effectuate switches between different types content. The pre-arranged sequence enables a communication application used for an on-line presentation to recognize changes and timing for switches between content items and automatically manage the switches to make smooth and seamless changes from one type of content to another.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures. Lastly, an example system and components of the system are discussed that may be employed to implement embodiments of the techniques described herein.

Example Environment

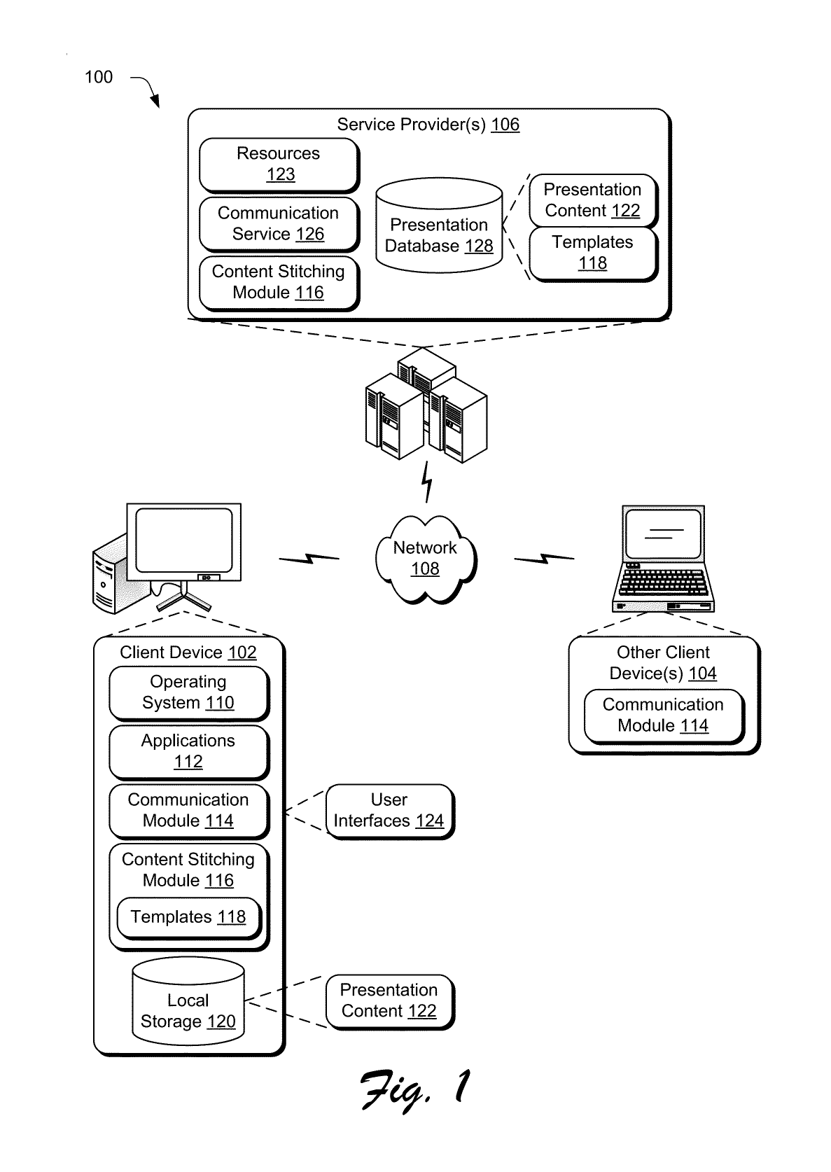

FIG. 1 is an illustration of an environment 100 in an example implementation that is operable to employ techniques described herein. The illustrated environment 100 includes a client device 102, an other client device 104, and a service provider 106 that are communicatively coupled via a network 108. The client device 102, other client device 104, and service provider 106 may be implemented by one or more computing devices and also may be representative of one or more entities.

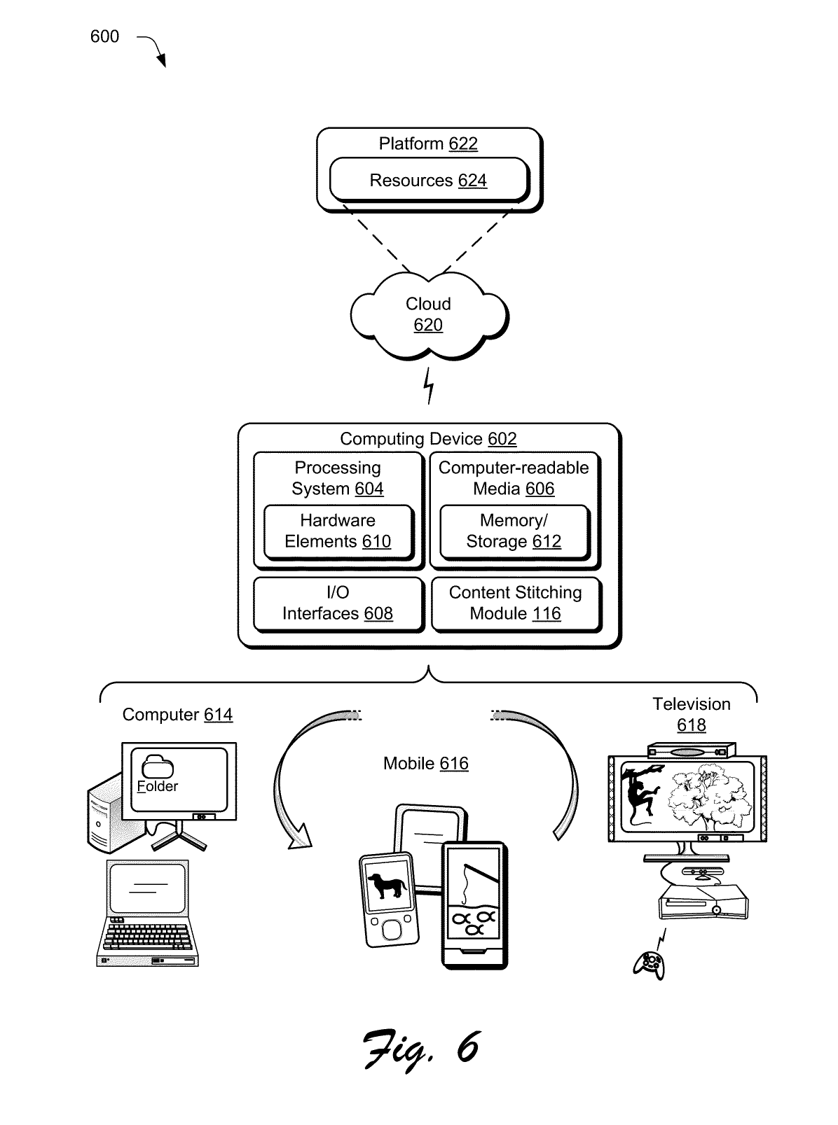

A computing device employed to implement aspects of the techniques described herein may be configured in a variety of ways. For example, a computing device may be configured as a computer that is capable of communicating over the network 108, such as a desktop computer, a mobile station, an entertainment appliance, a set-top box communicatively coupled to a display device, a wireless phone, a game console, and so forth. Thus, the computing device may range from full resource devices with substantial memory and processor resources (e.g., personal computers, game consoles, tablets, laptops) to a low-resource device with limited memory and/or processing resources (e.g., traditional set-top boxes, hand-held devices, mobile phones, game consoles). Additionally, although a single computing device is shown in some instances, the computing device may be representative of a plurality of different devices, such as multiple servers of the service provider 106 utilized by a business to perform operations, and so on. Further examples of computing systems and devices suitable to implement techniques described herein are described below in relation to FIG. 6.

Although the network 108 is illustrated as the Internet, the network may assume a wide variety of configurations. For example, the network 108 may include a wide area network (WAN), a local area network (LAN), a wireless network, a public telephone network, an intranet, a peer-to-peer network, and so on. Further, although a single network 108 is shown, the network 108 may be configured to include multiple networks.

The client device 102 is further illustrated as including an operating system 110. The operating system 110 is configured to abstract underlying functionality of the underlying device to applications 112 that are executable on the client device 102. For example, the operating system 110 may abstract processing, memory, network, and/or display functionality such that the applications 112 may be written without knowing “how” this underlying functionality is implemented. The application 112, for instance, may provide data to the operating system 110 to be rendered and displayed by a display device as illustrated without understanding how this rendering will be performed. A variety of applications 112 typically associated with client devices are contemplated including, but not limited to, a productivity suite that integrates multiple office productivity modules, a web browser, games, a multi-media player, a word processor, a spreadsheet program, a photo manager, and so forth.

The client device 102 and other client device are each illustrated as including a communication module 114. The communication modules are representative of functionality to enable various kinds of communications via the network 108. For instance, communication modules 114 may be employed to facilitate communication sessions between a diversity of client devices described above and below including mobile devices, traditional computing devices, tablets and slates, gaming consoles, and set-top boxes to name a few examples, as well as combination of devices in cross-platform sessions. Examples of the communication modules include a voice communication application (e.g., a VoIP client), a video communication application, a messaging application, a content sharing application, a browser to access web content and combinations thereof. The communication module 114 for instance, enables different communication modalities to be combined to provide diverse communication scenario. This includes but is not limited to implementing functionality for user presence indications, instant messaging, voice, video communications, online meeting experiences, instant messaging (IM) and voice calling. Further, the communication module may be operable to access online resources (e.g., content and services), browse web pages and sites, establish communication connections with service providers and other clients, and so forth. In at least some implementations, the communication module 114 represents an application that is deployed to and installed locally on a client device. Additionally or alternatively, the communication module 114 may be implemented all or in part as a remote application that is accessed and executed via a web browser (e.g., a web application), as a remote service from a provider, using peer-to-peer techniques, and so forth.

Additionally, the client device 102 may include a content stitching module 116 configured to implement techniques for content stitching templates as described herein. As illustrated, the content stitching module 116 may be provided as a standalone module that various applications 112 may make use of to form templates 118 as described herein. In addition or alternatively, the content stitching module 116 may be implemented as a component of another application, such as being an integrated component of the communication module 114.

The content stitching module may be configured to produce templates 118 that define a structure for a presentation that is independent of underlying content. Effectively, the template 118 is designed to arrange building blocks for different types of content in a selected sequence and provide constructs to facilitate association of the template with content items to produce a resultant presentation. As the templates are independent of underlying content, a particular template may be used and reused to generate different presentation having the same structures as defined by the particular template. Thus, the content stitching module 116 is generally configured to facilitate creation of presentations that “stitch together” different types of content in a way that enables managed and seamless switching from one type of content to another when the presentation is output for viewing by the viewers, additional details of which are described in relation to the following figures.

As further shown if FIG. 1, the client device 102 may include local storage 120 in which various presentation content 122 may be stored, including but not limited to slideshow files, audio files, videos, links, software demonstration packages, and other types of content that may be used to create a presentation. Items of presentation content 122 from local storage 120 may be linked to, incorporated with, or otherwise associated with a template to form as corresponding presentation. Other items of presentation content 122 for a presentation may be available from remote sources, such as the service provider 106, a particular web site, another client, and so forth. Remote content may be downloaded to the client and/or local storage 120 for inclusion in the presentation. Additionally or alternatively, at least some content may be maintained at remote locations and the presentation may be configured to link to the content at remote locations. Thus, a presentation may include a combination of various items of presentation content 122 including combinations of local and remote content with respect to the particular client device.

The service provider 106 includes functionality operable to manage various resources 123 that may be made available over the network 108. For example, service provider 106 may provide various resources 123 via webpages or other user interfaces 124 that are communicated over the network for output by one or more clients via a web browser or other client application. The service provider 106 is configured to manage access to the resources 123, performance of the resources, and configuration of user interfaces 124 to provide the resources 123, and so on. The service provider 106 may represent one or more server devices used to provide the various resources 123.

Generally, resources 123 made accessible by a service provider 106 may include any suitable combination of services and/or content typically made available over a network by one or more providers. Some examples of services include, but are not limited to, a search service, an email service, an instant messaging service, an online productivity suite, and an authentication service to control access of clients to the resources 123. Content may include various combinations of text, multi-media streams, documents, application files, photos, audio/video files animations, images, web pages, web applications, device applications, content for display by a browser or other client application, and the like.

One particular example of a resource 123 that may be accessible via the service provider is a communication service 126 as represented in FIG. 1. The communication service 126 is representative of a service to perform various tasks for management of communications between the client device 102 and other client device 104. The communication service 126, for instance, may be operable to manage initiation, moderation, and termination of communication sessions for the clients. The communication service 126 may integrate functionality for one or more of VoIP calls, online meeting and conferencing, screen sharing, a unified communications and collaboration (UC&C) service, instant messaging, video chats, and so forth. The communication service 126 may also be implemented as or be connected to a private branch exchange (PBX) in communication with a Public Switched Telephone Network (“PSTN”) to enable voice communication between the client terminal and other devices.

In an implementation, the communication service 126 may also configured to provide a content stitching module 116 that may be accessed over the network 108 for execution to create templates 118 and corresponding presentation. Here, the content stitching module 116 may be a module that is exposed for download and execution locally at the clients. The content stitching module 116 may alternatively be configured as a cloud-based service or a web application that is operable via a web browser or other client application corresponding to the web application that is deployed to the clients. Thus, functionality described herein in relation to the content stitching module 116 may be made available locally at a client device, over the network 108 from the service provider 106, or in both of these ways.

The service provider 106 is additionally depicted as having a presentation database 128 that may be configured to store presentation content 122 in addition to or in lieu of storing the content in local storage 120. Presentation content 122 in the presentation database 128 is representative of content available from a remote location/source that may be associated with a presentation. Naturally, additional sources such as third party providers, other clients, and other web-accessible site and locations may also maintain content that may be employed to create presentations.

The presentation database 128 also represents an online repository for presentations. For example, presentations created from templates 118 may be upload via the communication service 126 to enable access during a communication session. The communication service 126 may then operate to stream the presentation to various viewing devices (e.g., clients) and/or enable downloading from the presentation database 128. The presentation may be streamed to multiple viewers substantially simultaneously as part of an online meeting and conferencing session, on-demand to individual viewers, at the direction of an owner of the presentation, and so forth. In addition, the presentation database 128 may include a library of templates 118 that may be made be made available for use with the content stitching module 116. The template library may be accessible via the communication service 126 to browse, select, download, or otherwise use a variety of different templates. Users may also be able to publish their own templates to the library and set access permissions to make the published template private (e.g., managed access to individuals or groups) or publicly available.

In at least some embodiments, clients may access the communication service 126 and other resources 123 provided by a service provider 106 through client/user accounts to which the clients are authenticated. For instance, to access resources 123, a client device may provide a username and password that are authenticated by an authentication service. When the authentication is successful (e.g., the client “is who they say they are”), the authentication service may pass a token (or other suitable authentication identifier/secret) to enable access to corresponding resources. A single authentication may correspond to one or more resources, such that authentication to a single account by a “single sign-on” may provide access to individual resources, resources from multiple service providers 106, and/or to an entire suite of resources available from a service provider 106. Authentication may also enable access to the presentation database 128 to publish and utilize templates 118 and/or presentation content 122.

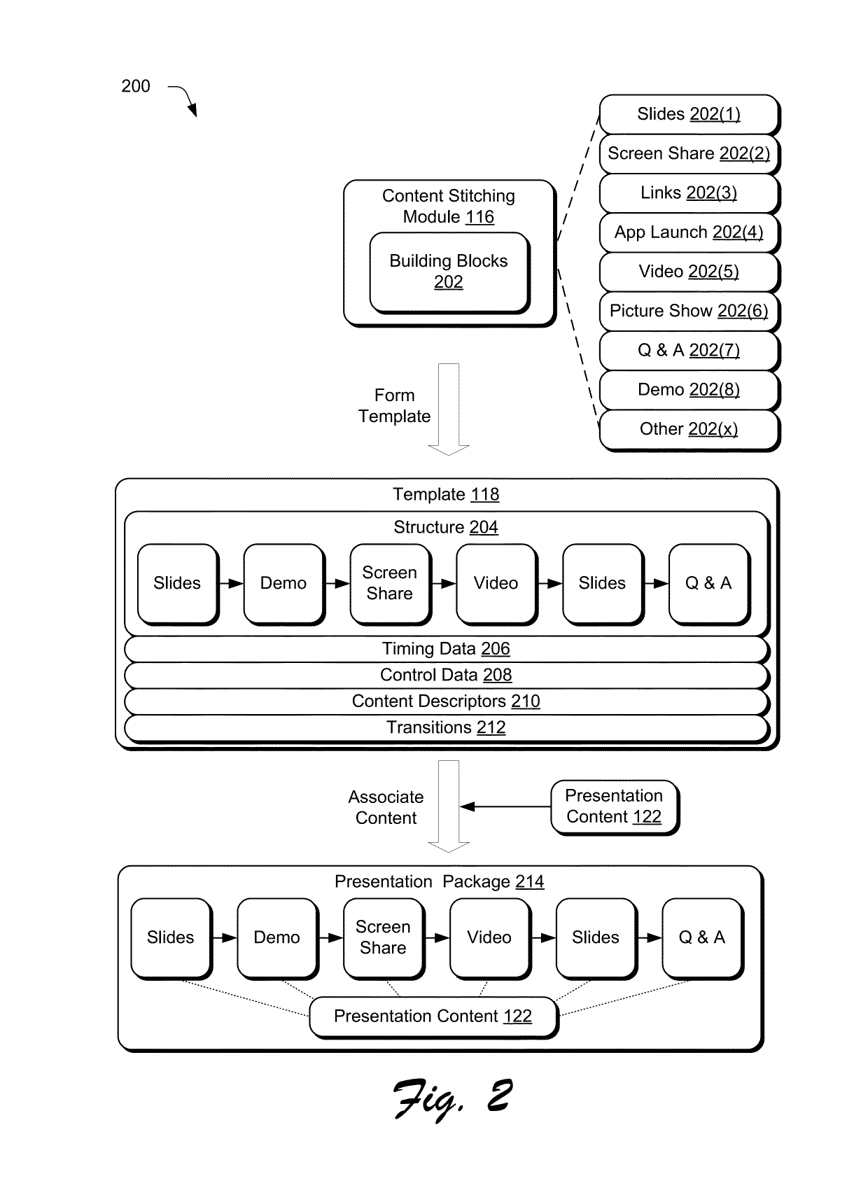

To further illustrate techniques for content stitching templates, consider now FIG. 2, which depicts a diagram showing some example scenarios for creation of a presentation from an example template, generally at 200. In particular, the example represents details regarding an example template and creation of a presentation based on the example template.

As noted, a template 118 is configured to define a structure for a presentation by arranging various building blocks 202 that correspond to different types of content. In one approach, the content stitching module 116 is configured to expose a plurality of building blocks 202 for selection by a user to facilitate creation of a template for a presentation. The structure defined by the template specifies a pre-arranged sequence for presentation content items included in presentations created based on the template. The template 118 is configured to define the structure/sequence for a presentation apart from dependence upon particular content items. Thus, the same template 118 may be used and reused with different content associations to form different presentations having the same structure.

By way of example, the building blocks for the different types of content may include, but are not limited to, building blocks configured to facilitate one or more of: output of a collection of slides 202(1) for a presentation application/slideshow, screen sharing 202(2) between client devices (by way of a communication service 126 or otherwise), links 202(3) for navigation/access to web pages and/or other online resources, application launching 202(4) to initiate execution of different applications, video playback 202(5), a picture show 202(6), a question and answer session 202(7), or a software demonstration 202(8). A variety of other 202(x) types of building blocks are also contemplated.

The building blocks 202 are configured to provide standard formats, protocols, implementing code, and constructs for specifying and handling corresponding types of content. Different kinds of building blocks 202 may be exposed via a user interface 124 such as via a menu, a drop-down pick list, selectable icons of a toolbar, a presentation creation dialog and/or other suitable user interface instrumentalities. The “creation” user interface enables a user to make selections from among the available building blocks to build a template for the presentation. In some scenarios, a user may arrange individual building blocks one to another to designate a structure for a presentation and produce a corresponding template. In addition or alternatively, a pre-configured, existing template may be selected from a library of available templates maintained in the presentation database 128, local storage 120, or otherwise. A user may choose to use an existing template as is or edit the existing template to add, remove, and rearrange building blocks to customize the template. Thus, the content stitching module 116 may enable creation of templates 118 from scratch as well as through modification of existing templates.

Accordingly, the content stitching module 116 is configured to form a template 118 that defines a structure 204 for the presentation by arranging building blocks selected from a plurality of building blocks 202 in accordance with user input. For instance, the example template 118 in FIG. 2 is represented as having a structure 204 that may be constructed in response to user selections from among the available building blocks 202. In the illustrated example, the template defines a structure 204 in which a presentation starts with a collection of slides and then progresses to a demonstration, a screen-sharing session, a video presentation, additional slides, and finally a question and answer session. This example structure may represent a structure for a sales pitch that is frequently employed by a sales representative with different products and/or different customers. By creating a template 118 that is independent of content in the manner described herein, the sales representative can separate the presentation structure from dependence upon particular presentation content and reuse the template again and again for different presentations.

The template 118 may also be configured to enable automatic and managed switching between content types to make smooth and seamless changes from one type of content to another. For example, the example template 118 is further illustrated as incorporating timing data 208, control data 208, and content descriptors 210. In addition, transitions 212 between different types of content such as animations, graphic effects, fading in/out, and so forth, may be specified for changes between different content.

The timing data 208, control data 208, and content descriptors 210 may be specified for each of the individual building blocks that make up the template 118. The template 118 may therefore reflect a combination of the data corresponding to each individual building block. The timing data 208 indicates timing for individual building blocks as well as the presentation as a whole. The timing data may facilitate playback of the different components of the presentation (e.g., different types of content) and managed switching between portions of the presentation. Timing data may also be used to synchronize different content such as to synchronize background audio to visual content. In some implementations, the timing data enables automatic playback/switching according to timing associated with each portion of the presentation. In addition or alternatively, the timing data 208 may indicate breaks and pauses that may be employed to conduct a presentation responsive to input from a user. In this case, managed switches between different content portions may occur based on designated input commands such as keystrokes, mouse clicks, touch input, gestures and so forth. As the structure 204 is predefined by the template 118, relatively simple input to advance the presentation (one click, a touch of the screen, pressing any key, etc.) may be employed to drive the presentation as opposed to a user having to manually navigate to find files, launch files, open different applications, make selections and so forth.

Control data 208 may be incorporated to provide a mechanism to convey information regarding the structure 204 and arrangement of content; types of content contained in the structure; code, script, and/or other components sufficient to locate, process, render, and/or output the different content; and so forth. For instance, the control data 208 may include identifiers, metadata, or other suitable constructs to enable both an originating client device and client devices of viewers to recognize the structure 204, types of content, and/or a pre-defined sequence for the content. Control data 208 may also include modules, plug-ins, script, or other components included with the template 118 to enable handling of the different types of content. Based in part on this information, devices may then be configured to prepare in advance for switching between types of content. This may involve pre-loading content and corresponding components to handle the content prior to switches indicated by the structure 204 in order to make smooth changes. For example, during a demonstration segment a screen sharing session may be initiated in the background automatically so that the screen sharing is “ready to go” at the end of the demonstration. Thus, a presenter does not have to make a series of manual selections to close the demonstration and launch the screen sharing. Various transitions 212 designated for the switches between different blocks/content types may also be applied as indicated by the template.

The content descriptors 210 are representative of fields, tags, script, references, links, and/or other suitable constructs incorporated in the template 118 that may be employed to associate presentation content 122 with the building blocks of the template. The template 118 as created may be independent of particular content. However, the content descriptors 210 provide mechanisms, formats, and/or syntax that may be employed to associate content with the template thereby producing a completed presentation.

As represented in FIG. 2, presentation content 122 may be associated with a template 118 to produce a resultant presentation package 214. This may involve associating each of the building blocks contained in the template with presentation content items using corresponding content descriptors 210. In particular, the content descriptors 210 may be used to create references (e.g., links) to presentation content 122. The references may refer to content that is available in local storage 120 or at a remote location, such as a presentation database 128 or other remote location. In various implementations, remotely located content may be downloaded to the local storage 120 or may be maintained at and accessed from the remote locations. In addition or alternatively, content descriptors 210 for at least some content items and/or types may be configured to incorporate the content as part of a presentation package for the resultant presentation, such as by embedding a document file, audio file, video file, or other presentation content 122 within the presentation package 214. Accordingly, a presentation that is created based on the template 118 may include embedded content as well as references and links to content from local and/or remote storage locations.

As mentioned, a template such as the example represented in FIG. 2 may be saved at a network accessible location for subsequent use to build presentations based on the template. Generally, the template 118 is saved without the associations to presentation content items. Thereafter, the template may be selected in connection with creating a presentation and additional selections may be made to associate content items with the template using the content descriptors 210. The resultant presentation package 214 may then be configured for display to one or more viewers in various ways. For instance, the presentation may be configured for display during an online communication session between clients. This may involve creating a collection of images (e.g., presentation frames) for display in succession during the presentation to represent the content. In addition or alternatively, the presentation may be uploaded and saved at a network accessible storage location accessible by the one or more viewers to view the presentation on demand (e.g., streaming the presentation over the network) or download the presentation to individual devices corresponding to the viewers.

Having considered the foregoing example environment, templates, and template creation scenarios, consider now a discussion of some further details of content stitching templates in relation to the following example procedures.

Example Procedures

The following discussion describes content stitching template techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference may be made to the environment 100 of FIG. 1 and the diagram 200 of FIG. 2. In at least some embodiments, the procedures may be performed by a suitably configured computing device, such as a client device that includes or otherwise makes use of a communication module 114 and/or a content stitching module 116.

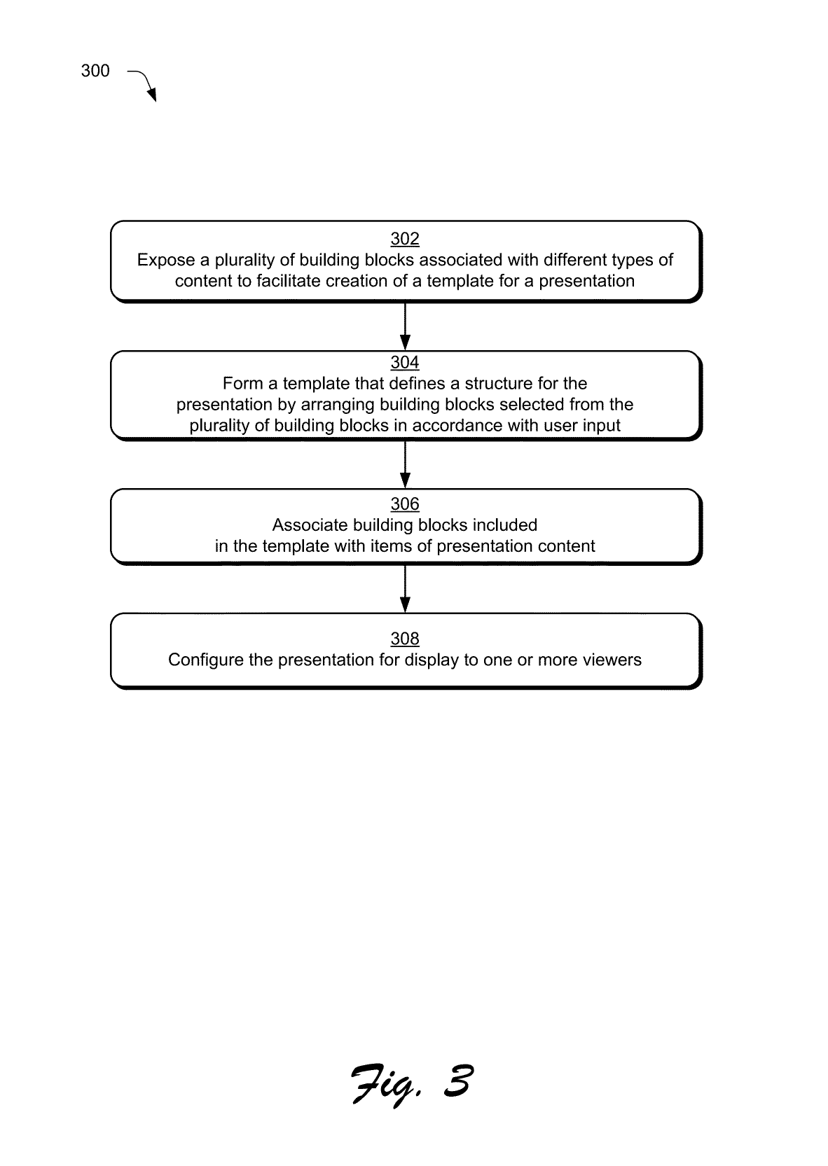

FIG. 3 is a flow diagram depicting an example procedure 300 to form a template in accordance with one or more implementations. A plurality of building blocks associated with different types of content is exposed to facilitate creation of a template for a presentation (block 302). A template is formed that defines a structure for the presentation by arranging building blocks selected from the plurality of building blocks in accordance with user input (block 304). The building blocks may be exposed in any suitable way. One this may occur is via a content creation user interface or dialog that is provide via a communication module 114 and/or a content stitching module 116 as noted above. In an implementation, visual representations of the structure may be presented and updated via the creation user interface as the user adds or modifies different building blocks in the template. In one particular example, the creation user interface may be configured to expose icons for different types of content that are selectable to insert a correspond building block as the next item in the template. The creation user interface may support drop and drag selection of the different building blocks, selection from a pick list, menu selections, voice commands, touch gestures, and/or other comparable techniques to choose and arrange building block to form a template.

Following formation of a template in the manner just described, building blocks included in the template are associated with items of presentation content (block 306) and the resultant presentation is configured for display to one or more viewers (block 308). For example, values for content descriptors 210 included in the template may be set to specify particular items of content to associate with each of the blocks in the template. A creation user interface may be configured to support association of content with a template in various ways. For example, content files may be selected and dragged to visual representations of the structure for particular blocks to cause association of the content files with the blocks. In addition or alternatively, references or links to content locations (local and/or remote) may be input via text fields corresponding to content descriptors 210 exposed via the creation user interface to cause the associations. This process forms a finished presentation package 214 that has the defined structure 204 of the template and associations to presentation content 122 as represented and discussed relation to FIG. 2.

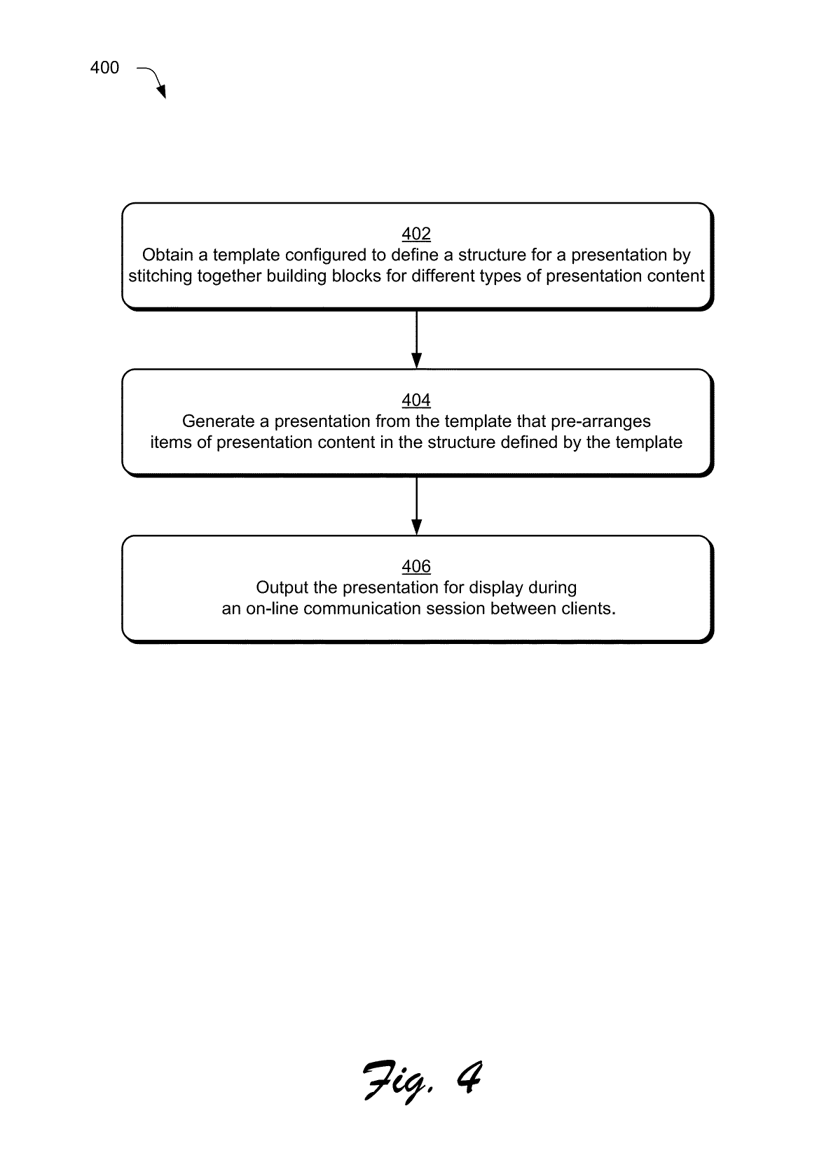

FIG. 4 is a flow diagram depicting an example procedure 400 to generate a presentation based on a template in accordance with one or more implementations.

A template is obtained that is configured to define a structure for a presentation by stitching together building blocks for different types of presentation content (block 402). Templates to create corresponding presentations may be obtained in various ways and from various different sources. For instance, one or more templates that are created may be saved as selectable options that are made available via a user interface for subsequent use to build presentations based on the template. Existing templates may be accessible via a content stitching module 116 associated with a client or that is available as web application/service from a service provider. In an implementation, a library of templates may also be maintained in a presentation database 128 for use with a communication module 114 or other application 112 that supports creation of presentations. Thus, an existing template may be saved to and obtained from local storage or a remote library of templates that is made accessible by a service provider over a network.

In addition to providing access to existing templates, the content stitching module may be further configured to expose a user interface to enable creation of a template by selections from among the building blocks for the different types of presentation content as described previously. Accordingly, “new” templates may be formed by arranging selected building blocks to define the structure for presentations according to selections input via the exposed user interface. A variety of different types of content and building blocks may be supported. Generally, a template may stitch together a combination of building blocks that includes multiple different types of presentation content. In one approach, a template is formed to define a structure for presentations that includes a collection of slides for a presentation platform (e.g., communication module 114) and at least one other type of presentation content.

In particular, a presentation that pre-arranges items of presentation content in the structure defined by the template is generated from the template (block 404). Generating the presentation may include setting values for content descriptors contained in the template to associate the presentation content items with the structure defined by the template. The approach of separating the presentation structure from particular content in the manner described herein enables the template to be used and reused to efficiently and quickly produce different presentations with the same structure, such as to create similar presentations for different potential customers or different products having customer or product specific content. In other words, the templates as described herein implement a presentation structure that is independent of content associations such that the template is reusable to produce multiple different presentations having the same structure as defined by the template used to build the presentations.

The presentation is output for display during an on-line communication session between clients (block 406). For instance, a content stitching module may be implemented as a component of a communication module 114 that enables online meetings, collaboration, and conferencing between two or more clients. The communication module 114 may be operable to establish and manage the on-line communication session between the clients. In an implementation, the communication module 114 is further configured to provide functionality for outputting presentations for display to viewers in the manner described herein.

During a communication session in which a presentation is output, the communication module 114 (by way of the content stitching module 116 or otherwise) is configured to recognize timing data, control data, and transitions defined by the template to facilitate managed switching back and forth between the different types of presentation content during output of the presentation. Notably, the communication module 114 may provide a common user experience for display of the different types of content. For example, different types of content may be exposed via a common presentation window provided via the communication module 114. Even if different applications or plug-ins are relied upon for handling some of the content for a presentation, the communication module 114 may operate to provide viewers with a managed experience and to switch seamlessly between different segments of the presentation, such that presentation appears polished and viewers may not even be aware that different underlying applications, plugin, and components are being invoked during the presentation. Accordingly the communication module 114 that includes or makes use of a content stitching module 116 provides an integrated platform for online presentations that may support and seamlessly handle different types of content that can be stitched together using the templates as described herein.

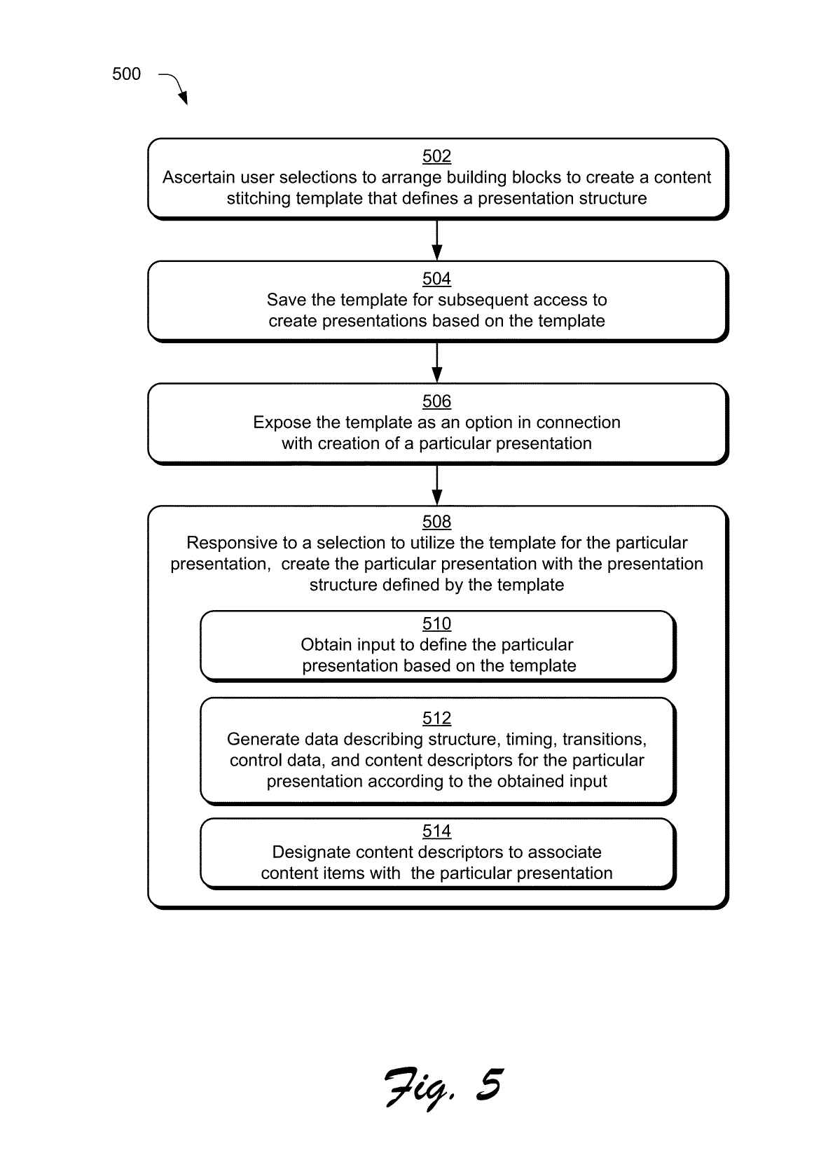

FIG. 5 is a flow diagram depicting an example procedure 500 to use a saved template to create a particular presentation in accordance with one or more implementations. User selections are ascertained to arrange building blocks to create a content stitching template that defines a presentation structure (block 502). This may occur via a suitable user interface and various different kinds of instrumentalities as described above. The user interface may be exposed via a content stitching module 116, a communication module 114, or other suitable application or service configured to facilitate creation of presentations. Then, the template is saved for subsequent access to create presentations based on the template (block 504). Templates may be saved locally or in a library of an online database as mentioned above. The template is exposed as an option in connection with creation of a particular presentation (block 506). For example, a user interface configured to facilitate creation of presentations may include functionality operable to access and utilize existing templates from one or more sources. For example, a list or other suitable representation of saved templates may be exposed in connection with a presentation creation dialog. The one or more sources may include but are not limited to a individual user's own saved templates stored locally or remotely, public templates available through an online service, and/or templates shared with the user by friends, colleagues, or groups with which the user is associated and accessible from a remote location, to name a few examples.

Responsive to a selection to utilize the template for the particular presentation, the particular presentation is created with the presentation structure defined by the template (block 508). The creation of the particular presentation may involve operations to obtain input to define the particular presentation based on the template (block 510) and generate data describing structure, timing, transitions, content descriptors, and control data for the particular presentation according to the obtained input (block 512). Structure, timing, transitions, content descriptors, and control data that is configured as discussed in relation to FIG. 2 may be generated as part of the presentation creation process. For example, selections to set timing for different blocks and apply different transitions (special effects, etc.) may be obtained via the user interface configured to facilitate creation of presentations. Corresponding control data for the different portions of the presentation may also be generated or modified in response to the selections. In addition, values for content descriptors may be designated to associate content items with the particular presentation (block 514). Designating the content descriptors may include identifying locations of the presentation content items. At least some presentation content items may then be retrieved from the identified locations for inclusion in a presentation package for the presentation. In addition or alternatively, references or links to some of the presentation content items at identified locations may be established by setting values of corresponding content descriptors.

Having considered some example procedures, consider now a discussion an example system and devices that may be employed to implement aspects of the techniques described herein in one or more implementations.

### Example System and Device

FIG. 6 illustrates an example system generally at 600 that includes an example computing device 602 that is representative of one or more computing systems and/or devices that may implement the various techniques described herein. The computing device 602 may be, for example, a server of a service provider, a device associated with the client (e.g., a client device), an on-chip system, and/or any other suitable computing device or computing system.

The example computing device 602 as illustrated includes a processing system 604, one or more computer-readable media 606, and one or more I/O interfaces 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware elements 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 606 is illustrated as including memory/storage 612. The memory/storage 612 represents memory/storage capacity associated with one or more computer-readable media. The memory/storage 612 may include volatile media (such as random access memory (RAM)) and/or nonvolatile media (such as read only memory (ROM), Flash memory, optical disks, magnetic disks, and so forth). The memory/storage 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “communication media.”

“Computer-readable storage media” refers to media and/or devices that enable storage of information in contrast to mere signal transmission, carrier waves, or signals per se. Thus, computer-readable storage media does not include signal bearing media or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Communication media” may refer to a signal-bearing medium that is configured to transmit instructions to the hardware of the computing device 602, such as via a network. Communication media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules including applications 112, communication module 114, content stitching module 116, communication service 126 and other program modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of modules as a module that is executable by the computing device 602 as software may be achieved at least partially in hardware, e.g., through use of computer-readable storage media and/or hardware elements 610 of the processing system. The instructions and/or functions may be executable/operable by one or more articles of manufacture (for example, one or more computing devices 602 and/or processing systems 604) to implement techniques, modules, and examples described herein.

As further illustrated in FIG. 6, the example system 600 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 600, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 602 may assume a variety of different configurations, such as for computer 614, mobile 616, and television 618 uses. Each of these configurations includes devices that may have generally different constructs and capabilities, and thus the computing device 602 may be configured according to one or more of the different device classes. For instance, the computing device 602 may be implemented as the computer 614 class of a device that includes a personal computer, desktop computer, a multi-screen computer, laptop computer, netbook, and so on.

The computing device 602 may also be implemented as the mobile 616 class of device that includes mobile devices, such as a mobile phone, portable music player, portable gaming device, a tablet computer, a multi-screen computer, and so on. The computing device 602 may also be implemented as the television 618 class of device that includes devices having or connected to generally larger screens in casual viewing environments. These devices include televisions, set-top boxes, gaming consoles, and so on.

The techniques described herein may be supported by these various configurations of the computing device 602 and are not limited to the specific examples of the techniques described herein. This is illustrated through inclusion of the content stitching module 116 on the computing device 602. The functionality of the content stitching module 116 and other modules may also be implemented all or in part through use of a distributed system, such as over a “cloud” 620 via a platform 622 as described below.

The cloud 620 includes and/or is representative of a platform 622 for resources 624. The platform 622 abstracts underlying functionality of hardware (e.g., servers) and software resources of the cloud 620. The resources 624 may include applications and/or data that can be utilized while computer processing is executed on servers that are remote from the computing device 602. Resources 624 can also include services provided over the Internet and/or through a subscriber network, such as a cellular or Wi-Fi network.

The platform 622 may abstract resources and functions to connect the computing device 602 with other computing devices. The platform 622 may also serve to abstract scaling of resources to provide a corresponding level of scale to encountered demand for the resources 624 that are implemented via the platform 622. Accordingly, in an interconnected device embodiment, implementation of functionality described herein may be distributed throughout the system 600. For example, the functionality may be implemented in part on the computing device 602 as well as via the platform 622 that abstracts the functionality of the cloud 620.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by a computing device comprising:
exposing a plurality of building blocks associated with different types of content to facilitate creation of a template for a presentation;
forming a template that defines a structure for the presentation by arranging building blocks selected from the plurality of building blocks in accordance with user input;
associating building blocks contained in the template with presentation content items; and
configuring the presentation for display to one or more viewers.

2. A method as described in claim 1, wherein the structure defined by the template specifies a pre-arranged sequence for presentation content items included in presentations created based on the template apart from dependence upon particular content items.

3. A method as described in claim 1, wherein the plurality of building blocks for the different types of content include building blocks configured to facilitate one or more of a collection of slides, screen sharing, links to web pages, application launching, video playback, a picture show, a question and answer session, or a software demonstration.

4. A method as described in claim 1, wherein the template further comprises timing data and control data for the presentation.

5. A method as described in claim 1, wherein the template is further configured to define transitions between the presentation content items.

6. A method as described in claim 1, wherein configuring the presentation for display comprises outputting the presentation for display during an online communication session between clients.

7. A method as described in claim 1, wherein configuring the presentation for display comprises saving the presentation at a network accessible storage location accessible by the one or more viewers to view the presentation.

8. A method as described in claim 1, further comprising saving the template without associations to presentation content items for subsequent use to build presentations based on the template.

9. One or more computer-readable storage media comprising instructions that, when executed by a client device, implement a content stitching module configured to perform operations comprising:
obtaining a template configured to define a structure for presentations by stitching together building blocks for different types of presentation content; and
generating a presentation from the template that pre-arranges presentation content items in accordance with the structure defined by the template.

10. One or more computer-readable storage media of claim 9, wherein the content stitching module is further configured to perform operations comprising outputting the presentation for display during an on-line communication session between two or more clients.

11. One or more computer-readable storage media of claim 9, wherein the content stitching module is implemented as a component of a communication client application that enables online meetings between two or more clients.

12. One or more computer readable storage media of claim 9, wherein the content stitching module is configured to recognize timing data, control data, and transitions defined by the template to facilitate managed switching back and forth between the different types of presentation content during output of the presentation.

13. One or more computer-readable storage media of claim 9, wherein generating the presentation comprises setting values for content descriptors contained in the template to associate the presentation content items with the structure defined by the template.

14. One or more computer-readable storage media of claim 9, wherein the template implements the structure independent of content associations such that the template is reusable to produce multiple different presentations having the same structure as defined by the template.

15. One or more computer-readable storage media of claim 9, wherein the template is formed to define the structure for presentations that include a collection of slides and at least one other type of presentation content.

16. One or more computer readable storage media of claim 9, wherein the content stitching module is further configured to perform operations comprising:
exposing a user interface to enable creation of the template by selections from among the building blocks for the different types of presentation content;
forming the template by arranging selected building blocks to define the structure for presentations according to selections input via the exposed user interface; and
saving the template as a selectable option available via the user interface for subsequent use to build presentations based on the template.

17. A computing device comprising:
a processing system; and
one or more modules configured to perform operations to implement content stitching including:
ascertaining user selections to arrange building blocks to create a content stitching template that defines a presentation structure;
saving the template for subsequent access to create presentations based on the content stitching template;
exposing the template as an option in connection with creation of a particular presentation; and
responsive to a selection to utilize the content stitching template for the particular presentation, creating the particular presentation with the presentation structure defined by the template.

18. The computing device of claim 17, wherein creating the particular presentation further comprises:
obtaining input to define the particular presentation based on the template; and
generating data describing the presentation structure, timing, transitions, control data, and content descriptors for the particular presentation according to the obtained input.

19. The computing device of claim 18, wherein creating the particular presentation further comprises designating the content descriptors to associate presentation content items with the particular presentation according to the obtained input.

20. The computing device of claim 19, wherein designating the content descriptors includes identifying locations of the presentation content items, retrieving at least some presentation content items from the identified locations for inclusion on the particular presentation, and setting values of the content descriptors to link to some other presentation content items.
